(19) United States
(12) Patent Application Publication
(10) Pub. No.: US 2024/0013953 A1
(43) Pub. Date: Jan. 11, 2024

(54) ANTI-ADHESIVE AND ABRASION-RESISTANT LINE

(71) Applicant: Kromberg & Schubert GmbH Cable & Wire, Rhede (DE)

(72) Inventors: Martin GREINER, Hemmingen (DE); Anne BREMER, Rhede (DE)

(21) Appl. No.: 18/347,444

(22) Filed: Jul. 5, 2023

(30) Foreign Application Priority Data
Jul. 6, 2022 (DE) 10 2022 116 849.2

(51) Int. Cl. H01B 13/22; H01B 7/18; H01B 13/24

(52) U.S. Cl. CPC H01B 13/228; H01B 7/187; H01B 13/24

(57) ABSTRACT

A cable or a line and a method for producing a modified cable sheath (20) of an electric line or a cable (1) are provided and characterized by
providing preferably spherical amorphous particles (30), and
implanting the amorphous particles (30) into the cable sheath (20) in such a way that a plurality of the amorphous particles (30) penetrate into the surface of the cable sheath (20) just as deep as their diameter, less deep or only minimally deeper. Kinetic energy of the particles during bombardment is selected as a function of particle properties (e.g., size and/or mass) and at least one property of the cable sheath (e.g., strength of the cable sheath) such that the amorphous particles (30) penetrate into the surface of the cable sheath (20) as deep as their diameter, less deep or only minimally deeper than their diameter. The amorphous particles (30) can be glass spheres.

### BACKGROUND

The invention relates to a solution for achieving an improved function in cables and lines, in particular with respect to strength and adhesion in the cable sheath, which has in particular improved mechanical properties and can further be employed with advantage as protection against animal bites, such as marten bites.

Solutions are known from the prior art in which a material for sheathing cables, hoses and tubes is provided which has at least one component which acts as a deterrent or repellent to animals and thus serves to prevent bite damage on vehicles, other technical products and installations such as cables, hydraulic hoses, retaining means, seals and the like. Numerous means and ways to prevent such bite damage are already known. However, they have various disadvantages.

For example, commercially available flavorings and/or fragrances with a deterrent or repellent effect must be renewed approximately every two weeks for use in the engine compartment of motor vehicles, wherein a complete engine wash has to be carried out before each spraying. This is not only impractical, but also complicated and expensive.

Further, there is already the possibility of armoring or of a particularly thick sheathing of the cables, hoses and tubes for protection against bite damage. However, this is both complicated and expensive.

Further, there is not only a need to achieve mechanical protection against marten bites, but also to provide a technical solution in general, to propose a mechanically improved line solution and a method for producing such lines at low cost. Further, a particular problem is that, in addition to the requirement for the mechanical resistance of a line, other requirements must also be taken into account, so that a solution is required which can be used in the same way for a plurality of sheathing materials.

A reliable solution is needed especially for lines which were produced via an extrusion method from thermoplastic, elastomer or thermoplastic-elastomer materials.

It is known that materials such as thermoplastics, thermoplastic elastomers and elastomers have a more or less high coefficient of friction, which can have a negative effect during processing and application. It is further known that elastomer materials in particular have a lower notch strength and high friction losses. As a result, these materials have a lower application potential.

Thus, it is further known to the person skilled in the art that during the processing of addition-curing silicone mixtures, a post-curing can take place at the surface, whereby a force-fit connection of adjacent layers is created and thus the end product can become unusable.

Known measures for adjusting the surface quality as desired, however, do not show the desired effect.

In particular, it is desirable to improve the abrasion resistance of the cable sheath. A further object of the present invention is to modify the adhesion properties favorably and in an advantageous manner.

Disadvantages are functional layers which are applied in addition to the actual sheath, for example by painting or co-extrusion. These are complicated and can have various disadvantages, such as adhesion problems or incompatibilities of the materials.

### SUMMARY

Advantageous aspects of example embodiments of the present invention are one or more of the following:
increased abrasion resistance;
protection against animal bite;
anti-adhesive behavior of the surface (especially for silicone lines); and
improved sliding properties of the surface.

Example embodiments of the present invention are provided to overcome the above-mentioned disadvantages and to propose a solution for cables and lines which can be used more universally, and for a cable/line that retains its function for as long as possible without any maintenance effort and in addition to the mentioned mechanical improvements of the cable/line.

Advantageous aspects of example embodiments of the present invention are achieved by the combination of features according to claim 1.

According to example embodiments of the invention, a method for producing a modified cable sheath of an electric line or a cable, in particular immediately after the extrusion of the cable, is therefore proposed with the following steps:
a. providing spherical amorphous particles,
b. implanting the amorphous particles into the cable sheath, in particular in such a way that a plurality of the amorphous particles penetrate into the surface of the cable sheath partially or just as deep as their diameter, less deep or only minimally deeper.

The implantation takes place by bombardment with accelerated particles around the entire cable circumference, thus around the entire cable, so that an approximately homogeneous implantation takes place at the surface or into the surface of the cable sheath. This improves abrasion resistance and reduces adhesion. For example, only partial implantation of particles would also be conceivable for a marten protection. In any case, an area of the surface which is large enough that sufficient protection against animal bites is created should be modified in accordance with example embodiments of the invention.

In an example embodiment of the invention, it is provided that the kinetic energy of the particles during bombardment is selected, in particular as a function of the particle properties, further in particular of the size and/or the particle mass and at least one property of the cable sheath, in particular the strength of the cable sheath, in such a way that a plurality of the amorphous particles penetrate into the surface of the cable sheath just as deep as their diameter, less deep or only minimally deeper than their diameter. This ensures on the one hand a sufficient effect in the outer cable region and on the other hand no unnecessarily thick cable sheath is required. The appropriate tuning can be determined by simple tests depending on the material of the cable. As soon as the particles penetrate too deeply into the sheath, the kinetic energy will be reduced accordingly.

It is further advantageous if the amorphous particles are glass spheres, in particular spherical glass spheres. By means of the crater-like regions in which the particles enter, it is possible to detect, by means of an inspection or by microscopic examination, whether the particles have penetrated sufficiently deep and are fixed into the cable sheath. Especially with deeply penetrated particles, a crater-like opening remains visible to the surface, since the surface does not close after implantation. However, this is a desired property, so that, for example, a marten immediately senses contact with the penetrated particles. It has been shown that animals, such as martens or rodents, then refrain from further gnawing when they bite on glass spheres or amorphous hard particles.

Apart from the production method, a further aspect of the present invention also relates to a cable or a line, in particular formed with a sheath for protection against animal bite, with one or more electrical conductors which are sheathed by an outer cable sheath, such as a cable sheath which was extruded from a thermoplastic, a thermoplastic elastomer or an elastomer. Of course, any other suitable sheathing materials can also be used, which represents a particular advantage of example embodiments of this invention.

A plurality of hard amorphous particles are introduced into the outer sheath region of the cable sheath, such as particles consisting of SiO₂ or silicate are embedded. Further, the particles are into the cable sheath from the outside by implantation or bombardment or by other suitable mechanical implantation methods.

It is particularly advantageous if the implantation of the particles takes place with the method described above. It is also conceivable to heat the cable sheath, for example to a temperature in the range from 60° C.-90° C., and then to carry out the bombardment or implantation with lower kinetic energy. The desired implantation result of the particles with respect to distribution and penetration depth can then be achieved by suitable matching of the process parameters.

In particular, it may be provided that at least a particle region of a partial number of the particles reaches up to the surface of the cable sheath or partially (less than the radius of the particle) projects therefrom.

It has been found that the spherical particles advantageously have a diameter in the range between 30 μm and 100 μm. Other particle sizes can also be used suitably depending on the cable and the cable size.

In addition, provision can be made for the surface of the particles to be provided with an adhesion promoter. As a result, during implantation, an adhesive connection is simultaneously, in addition to a form-fit connection.

Other advantageous further refinements of the invention are indicated in the subclaims or are illustrated in more detail below together with the description of the illustrative embodiment of the invention with reference to the FIGURE.

### BRIEF DESCRIPTION OF DRAWINGS

Other advantageous further developments of example embodiments of the invention are designated in the dependent claims or are represented in further detail below along with the description of example embodiments of the invention with reference to the FIGURE. In the drawing:

FIG. 1 shows a schematic view of a cable according to the invention in cross section.

### DETAILED DESCRIPTION OF ILLUSTRATIVE EMBODIMENTS

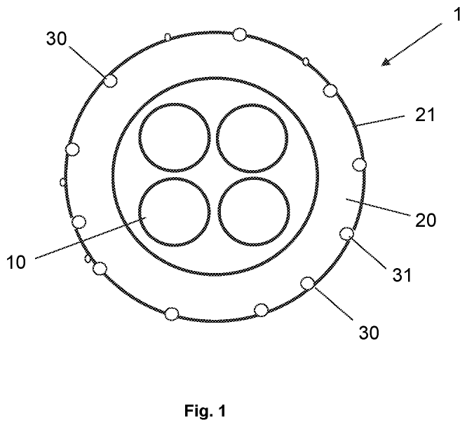

FIG. 1 is merely a schematic example and shows a cable 1 formed with a sheath for protection against animal bite, with several electrical conductors which are sheathed by an outer cable sheath 20.

By way of example, a plurality of hard amorphous particles 30 are into the outer sheath region 21 of the cable sheath 20 by implantation, i.e. in this case bombardment with particles 30 which were accelerated to a certain kinetic energy and have then penetrated the cable sheath 20 from the outside. The particles shown possess a spherical shape. In practice, the number of particles will be significantly higher, so that a structure is achieved on the surface. By way of example, particles 30 are shown which, as intended, have penetrated into the cable sheath 20 less deeply than the diameter, just as deep as the diameter and somewhat deeper than their diameter.

Thus, the particles 30 have been accelerated onto the cable sheath in such a way that at least an outer particle region 31 thereof reaches up to the surface of the cable sheath 20.

Advantageous aspects of example embodiments of the present invention are one or more of the following:
increased abrasion resistance;
protection against animal bite;
anti-adhesive behavior of the surface (especially for silicone lines); and
improved sliding properties of the surface.

Example embodiments of the present invention are provided to overcome the above-mentioned disadvantages and to propose a solution for cables and lines which can be used more universally, and for a cable/line that retains its function for as long as possible without any maintenance effort and in addition to the mentioned mechanical improvements of the cable/line.

Advantageous aspects of example embodiments of the present invention are achieved by the combination of features in the claims.

According to example embodiments of the invention, a method for producing a modified cable sheath of an electric line or a cable, in particular immediately after the extrusion of the cable, is therefore proposed with the following steps:
c. providing spherical amorphous particles,
d. implanting the amorphous particles into the cable sheath, in particular in such a way that a plurality of the amorphous particles penetrate into the surface of the cable sheath partially or just as deep as their diameter, less deep or only minimally deeper.

The implantation takes place by bombardment with accelerated particles around the entire cable circumference, thus around the entire cable, so that an approximately homogeneous implantation takes place at the surface or into the surface of the cable sheath. This improves abrasion resistance and reduces adhesion. For example, only partial implantation of particles would also be conceivable for a marten protection. In any case, an area of the surface which is large enough that sufficient protection against animal bites is created should be modified in accordance with example embodiments of the invention.

In an example embodiment of the invention, it is provided that the kinetic energy of the particles during bombardment is selected, in particular as a function of the particle properties, further in particular of the size and/or the particle mass and at least one property of the cable sheath, in particular the strength of the cable sheath, in such a way that a plurality of the amorphous particles penetrate into the surface of the cable sheath just as deep as their diameter, less deep or only minimally deeper than their diameter. This ensures on the one hand a sufficient effect in the outer cable region and on the other hand no unnecessarily thick cable sheath is required. The appropriate tuning can be determined by simple tests depending on the material of the cable. As soon as the particles penetrate too deeply into the sheath, the kinetic energy will be reduced accordingly.

It is further advantageous if the amorphous particles are glass spheres, in particular spherical glass spheres. By means of the crater-like regions in which the particles enter, it is possible to detect, by means of an inspection or by microscopic examination, whether the particles have penetrated sufficiently deep and are fixed into the cable sheath. Especially with deeply penetrated particles, a crater-like opening remains visible to the surface, since the surface does not close after implantation. However, this is a desired property, so that, for example, a marten immediately senses contact with the penetrated particles. It has been shown that animals, such as martens or rodents, then refrain from further gnawing when they bite on glass spheres or amorphous hard particles.

Apart from the production method, a further aspect of the present invention also relates to a cable or a line, in particular formed with a sheath for protection against animal bite, with one or more electrical conductors which are sheathed by an outer cable sheath, such as a cable sheath which was extruded from a thermoplastic, a thermoplastic elastomer or an elastomer. Of course, any other suitable sheathing materials can also be used, which represents a particular advantage of example embodiments of this invention.

A plurality of hard amorphous particles are introduced into the outer sheath region of the cable sheath, such as particles consisting of SiO₂ or silicate are embedded. Further, the particles are into the cable sheath from the outside by implantation or bombardment or by other suitable mechanical implantation methods.

It is particularly advantageous if the implantation of the particles takes place with the method described above. It is also conceivable to heat the cable sheath, for example to a temperature in the range from 60° C.-90° C., and then to carry out the bombardment or implantation with lower kinetic energy. The desired implantation result of the particles with respect to distribution and penetration depth can then be achieved by suitable matching of the process parameters.

In particular, it may be provided that at least a particle region of a partial number of the particles reaches up to the surface of the cable sheath or partially (less than the radius of the particle) projects therefrom.

It has been found that the spherical particles advantageously have a diameter in the range between 30 μm and 100 μm. Other particle sizes can also be used suitably depending on the cable and the cable size.

In addition, provision can be made for the surface of the particles to be provided with an adhesion promoter. As a result, during implantation, an adhesive connection is simultaneously, in addition to a form-fit connection

1. A method for producing a modified cable sheath (20) of an electric line or a cable (1), having the steps of:
a. providing preferably spherical amorphous particles (30),
b. implanting the amorphous particles (30) into the cable sheath (20), in particular by bombardment, in such a way that a plurality of the amorphous particles (30) penetrate into the surface of the cable sheath (20) just as deep as their diameter, less deep or only minimally deeper.

2. The method according to claim 1, wherein the kinetic energy of the particles during bombardment is selected as a function of the particle properties, in particular the size and/or the particle mass and at least one property of the cable sheath, in particular the strength of the cable sheath, such that a plurality of the amorphous particles (30) penetrate into the surface of the cable sheath (20) just as deep as their diameter, less deep or only minimally deeper than their diameter.

3. The method according to claim 1, wherein the amorphous particles (30) are glass spheres, in particular spherical glass spheres.

4. A Cable or line (1), in particular formed with a sheath for protection against animal bite, with one or more electrical conductors (10) which are sheathed by an outer cable sheath (20), preferably a cable sheath (20) which was extruded from a thermoplastic, a thermoplastic elastomer or an elastomer, wherein a plurality of hard amorphous particles (30), preferably particles (30) consisting of SiO₂ or silicate, are embedded in the outer sheath region (21) of the cable sheath (20), preferably introduced into the cable sheath from the outside by implantation or bombardment.

5. The cable or line (1) according to claim 4, characterized in that the implantation of the particles (30) was effected by a method having the steps of:
a. providing preferably spherical amorphous particles (30),
b. implanting the amorphous particles (30) into the cable sheath (20), in particular by bombardment, in such a way that a plurality of the amorphous particles (30) penetrate into the surface of the cable sheath (20) just as deep as their diameter, less deep or only minimally deeper.

6. The cable or line (1) according to claim 5, characterized in that the particles (30) are spherical.

7. The cable or line (1) according to claim 4, characterized in that a partial number of the particles (30) with at least one particle region (31) reaching up to the surface of the cable sheath (20) are introduced into the cable sheath (20).

8. The cable or line (1) according to claim 5, characterized in that the particles (30) have a diameter in the range between 30 μm and 100 μm.

9. The cable or line (1) according to claim 4, characterized in that the surface of the particles (30) is provided with an adhesion promoter.

10. Use of a cable or a line (1) according to claim 4 as a marten bite or animal bite protection.
